(19) United States
(12) Patent Application Publication
(10) Pub. No.: US 2006/0159344 A1
(43) Pub. Date: Jul. 20, 2006

(54) Method and system for three-dimensional handwriting recognition

(76) Inventors: Xiaoling Shao, Shanghai (CN); Jiawen Tu, Shanghai (CN); Lei Feng, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/540,793

(22) PCT Filed: Dec. 22, 2003
(86) PCT No.: PCT/IB03/06223

§ 371 Date: Dec. 27, 2005

(30) Foreign Application Priority Data
Dec. 26, 2002 (CN) 02159784.7

(51) Int. Cl. G06K 9/18

(52) U.S. Cl. 382/186

(57) ABSTRACT

The present invention relates to three-dimensional (3D) handwriting recognition methods and systems. The present invention provides a 3D handwriting recognition method and corresponding system which allows to generate 3D motion data by tracking corresponding 3D motion, calculate corresponding 3D coordinates, construct corresponding 3D tracks, derive 2D projection plane based on some strokes 3D tracks of on character, and generate 2D image for handwriting recognition by mapping the 3D tracks onto the said 2D projection plane. The 3D handwriting recognition method according to the present invention can use the processing power of system more efficiently and highly improve the system performance. So that the system can get the final input result in a much shorter time after the user finishes writing a character without a long time waiting between two characters input, thus the user has more pleased and natural input experience.

### TECHNICAL FIELD

The present invention relates generally to handwriting recognition technology. More particularly, relates to 3D handwriting recognition method and systems.

### BACKGROUND OF THE INVENTION

Handwriting recognition is a technology, by which intelligence systems can identify handwritten characters and symbols. Because this technology can free people from operating keyboard and allows users to write and draw in a more natural way, so it has been applied widely.

At present, the minimum request for the input equipment is a mouse. For writing by a mouse, the user usually needs to push the mouse button and hold it, then move the mouse pointer to form strokes of a character or symbol till complete the whole character or symbol.

The popular handwriting input devices, such as touchpen and tablet are used in traditional handheld devices such as PDA, or connected to computer by USB port or serial port. Handheld device usually uses touchpen and touch panel to help users to complete input function. Most handheld devices such as PDA have this kind of input equipment.

Another kind of handwriting input equipment can be a pen, which allows users writing or drawing on a piece of common paper naturally and easily. Then, transmits the data to the receive units with recognition function, such as cell-phone, PDA or PC.

All these above traditional input equipments apply 2D input method. Users must write on physical intermedia, such as tablet, touch panel, or notebook etc. This limits the application scope of handwriting input. For example, if one wants to write some criticism during a speech or performance, he has to find a physical medium, such as a tablet or a notebook. This is very inconvenient for a user who is standing and giving a speech. Equally, in a mobile environment, such as a car, a bus, or subway, writing on a physical medium by a touchpen is very inconvenient too.

An improved handwriting recognition method is provided in the patent application Num. 02144248.7 with the title “Three-Dimensional (3D) Handwriting Recognition Methods And Systems”. The said method allows users to write freely in a 3D space without any physical intermedia, such as notebooks or tablets. This method can bring users more Flexibility and convenience, and free users from the physical medium required in 2D handwriting recognition.

By mapping 3D tracks onto a 2D plane, said method derives the corresponding 2D image for handwriting recognition based on 3D tracks. To derive the corresponding 2D image for handwriting recognition based on 3D tracks comprising the following steps: sample some points from 3D track; after finishing a character or symbol, derive a 2D plane from all sample points; map 3D tracks onto said 2D plane to generate corresponding 2D image for handwriting recognition.

The said system starts to derive 2D plane after the user has finished writing a whole character or symbol. Only after the 2D plane has been derived, 3D tracks data can be transform to 2D image. Thereby, system does not calculate while the user is writing, which causes the time from the user finished writing to got the result is too long.

According to these, it is necessary to provide an improved 3D handwriting recognition method and corresponding systems to resolve said problems.

### SUMMARY OF THE INVENTION

The main goal of the present invention is to provide three-dimensional (3D) handwriting recognition methods and corresponding systems, which can make the use of the processing ability of system more efficiency, and get the final result in shorter time.

According to the present invention, a 3D handwriting recognition method and corresponding system is provided, which allows to generate 3D motion data by tracking corresponding 3D motion, calculate corresponding 3D coordinates, construct corresponding 3D tracks, derive 2D projection plane based on the 3D tracks of some strokes of a character, and generate 2D image for handwriting recognition by mapping the 3D tracks onto the said 2D projection plane.

Furthermore, the present invention defines stroke by part 3D tracks of a character, and judges if there are enough differences to distinguish two different strokes. Then, derives 2D projection plane by 3D data of the sample points coming from the tracks of the two differentiable strokes. Finally, derives the corresponding 2D image for handwriting recognition by mapping the 3D tracks of a character onto said 2D projection plane.

The 3D handwriting recognition method provided in the present invention can utilize the processing ability of the recognition system more effectively, so as to get the result more rapidly, and make users feel more freely and happy while inputting data.

More intact understanding of the present invention can be gotten according to the following claims and descriptions referencing the drawings.

### BRIEF DESCRIPTION OF THE DRAWINGS

The invention is explained in further detail, and by way of example, with reference to the accompanying drawings wherein:

FIG. 1 is a flow chart showing the process of 3D handwriting recognition in an embodiment based on the present invention.

FIG. 2 is a sketch map of defining different strokes in an embodiment based on the present invention.

FIG. 3 is a figure showing the 3D handwriting recognition system in an embodiment based on the present invention.

### DETAILED DESCRIPTION OF THE EMBODIMENT

Further description is given bellow referencing to the attached drawings. The method introduced in the patent application Num. 02144248.7 with the title “Three-Dimensional (3D) Handwriting Recognition Methods And Systems” is cited here to keep the integrality of the present invention.

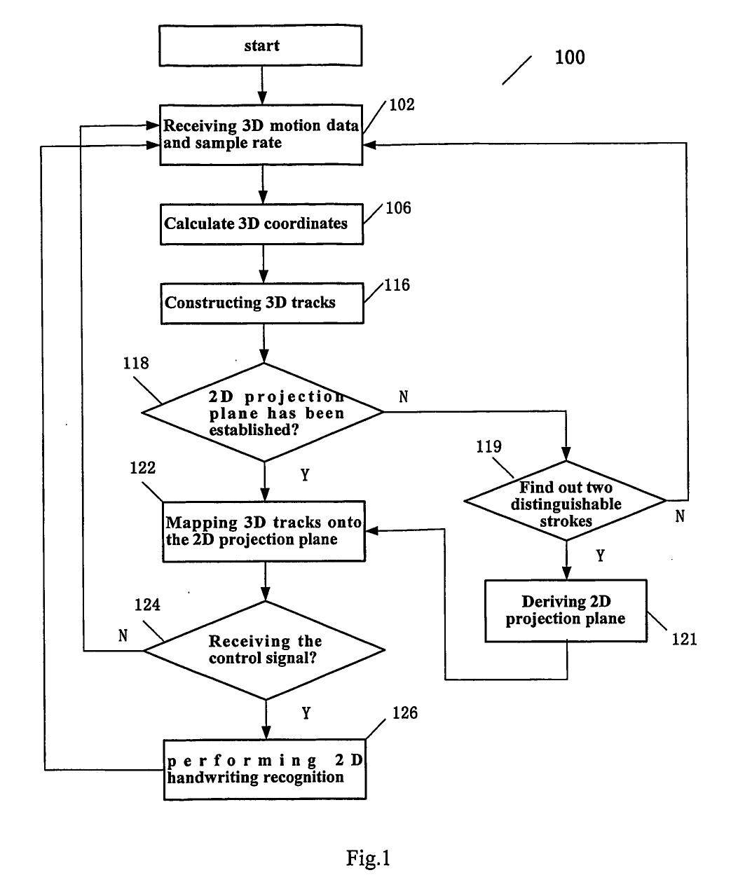

FIG. 1 is a flow chart describing the 3D handwriting recognition process 100 in an embodiment of the present invention. As FIG. 1 showing, after receiving the 3D movement data and the sampling rate (step 102), based on the received data, system regards the start point of the motion as the origin, calculates the corresponding 3D coordinates of every sample point on X, Y, Z axes (step 106). Every sample point is also regarded as the reference point of the coordinate of the next point. The sampling rate can be confirmed and adjusted dynamically based on for example the speed of the movement.

It can be done in the following way. For example, first, confirm the initial speed of the movement related to handwriting. Then, recognition equipment can adjust sampling rate dynamically based on the moving speed of the last sample point. The speed higher, the sampling rate higher, and vice versa. The precision of handwriting recognition can be increased by adjusting sampling rate dynamically, because only the sample points whose number is neither too many nor too few, can be used to form characters or symbols. Furthermore, it can reduce the system consumption.

Systems calculate the 3D coordinates continuously based on 3D motion data, construct the corresponding 3D tracks based on the received 3D coordinates (step 116), and then, map it onto a 2D projection plane (step 122). Till receiving a control signal, which represents that a character or symbol has been completed, the 2D mapping track of the whole character is constructed successfully. Then, traditional 2D handwriting recognition can be carried out (step 126).

In the said process, first, a suitable 2D projection plane must be found (step 118), so as to map 3D tracks onto the 2D projection plane. Among one of the best example of the present invention, a suitable 2D projection plane is derived (step 121) by the first and second differentiable stroke (step 119).

In order to get the first and second differentiable stroke, must define different strokes according to the received 3D tracks first.

For a 3D track data array Nₘᵢₙ=3, if the every point in it moves in the same direction, namely both ΔPx(i)=Px(i+1)−Px(i) and ΔPx(i−1) are positive, negative, or zero, and the same to ΔPy(i) & ΔPz(i), we can regard that they belong to one same stoke. Otherwise, they belong to different strokes. Said Px(i), Py(i) and Pz(i) represent the coordinates of point P(i) in direction x, y, and z respectively.

For example, if all ΔPx(i) (0<i<k) are negative, while ΔPx(k) are positive, the 3D track data array P₁,P₂, . . . ,Pₖ₋₂,Pₖ₋₁,Pₖ belong to one stroke, and another stroke starts at the point Pₖ₊₁.

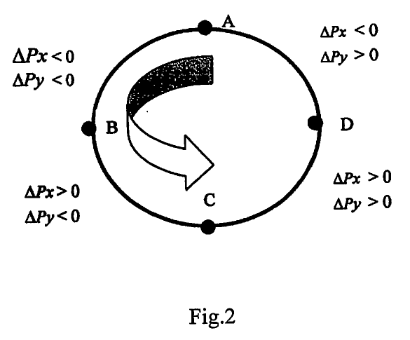

FIG. 2 shows the 2D image of “0” in Chinese character. 2D image is used here just to simplify the solving method, and the idea is the same in 3D situation.

All points from A to B can be considered belonging to one stroke (stroke AB), because all ΔPx(i) and ΔPy(i) (P(i) is a point between A and B) are negative. Though the ΔPy(i) of the points from B to C are still negative, these points do not belong to stroke AB, because the ΔPx(i) of these points become positive. Apply the same idea to the remained part of the character, and the result can be gotten that there are 4 strokes in this character.

Because that people's hands can not move as a machine, so the real input 3D movement will not be very precise, which will cause some difference between the moving directions of the practical input movement and the ideal input movement. So it is needed to define an extremum Nₘᵢₙ (Nₘᵢₙ is a integer and Nₘᵢₙ>0) to identify different strokes. If the number of the sequential points moving in different direction is less than Nₘᵢₙ, they will be regarded as “noise”, and not be calculated as effective sample points.

In the present example, we make Nₘᵢₙ=3. For every point, we need to consider the adjacent tow points before and after it to confirm its moving direction. Thereby, if ΔPx(i), ΔPy(i) and ΔPz(i) (0<i<k) are all the same positive or negative or zero, the 3D track data array P₁,P₂, . . . ,Pₖ₋₂,Pₖ₋₁,Pₖ belong to one stroke. However, the three points Pₖ₊₁, Pₖ₊₂, Pₖ₊₃ following the point Pₖ move in the different direction, so the points from P₁ to Pₖ belong to the first stroke, and the points following Pₖ do not belong to it.

In others examples of the present invention, Nₘᵢₙ (Nₘᵢₙ is a integer and Nₘᵢₙ>0) can be adjusted to a suitable number.

The second stroke can be found in the same way.

Then, it is needed to judge whether the two strokes can be distinguished or not.

Obviously, the distance between two differentiable strokes should not be very close. For stroke A and B, we define that the distance from point B₁(x₁,y₁,z₁) on stroke B to stroke A is the length between point B₁(x₁,y₁,z₁) and the nearest point on stroke A. While the average distance of all N_{b} points on stroke B to stroke A, namely Σd₁/N_{b}, is longer than the scheduled data dₘᵢₙ, we can conclude that stroke A and stroke B are differentiable.

In some good examples of the present invention, dₘᵢₙ is set to 0.5 cm. In other examples, it can be set to other value above 0.

If the result is differentiable, we get the two differentiable strokes (step 119). Otherwise, it is needed to continue defining the new input 3D stroke, and then judge whether there are two differentiable strokes or not.

In order to construct the 2D projection plane (step 121), at least 3 points not on the same line are needed. If there are Nₐ points on stroke A and N_{b} points on B, we can extract nₐ points of A and n_{b} points of B, meeting the condition that 0<nₐ<Nₐ, 0<n_{b}<N_{b}, nₐ+n_{b}≧3, and these points are not on the same line.

In the present example, we extract the points from the two differentiable strokes. In other examples, it can be achieved just by extracting at least 3 points not on the same line.

In the present example, n=nₐ+n_{b} points are needed. Actually, just n=nₐ+n_{b}≧3 points are enough to complete the tasks in the present invention.

According to geometry principle, a suitable 2D projection plane is a plane, to which the sum of the square of distance of every sample points is minimum. Supposing that the coordinates of n points are: (x₁,y₁,z₁),(x₂,y₂,z₂) . . . (xₙ,yₙ,zₙ), the equation of the plane is Ax+By+Cz+D=0, among which A²+B²+C²≠0. Now, the value of A, B, C, D must be gotten. The distance from point (x₁,y₁,z₁) to the plane is given by:

$${d}_{1} = \frac{\vert {Ax}_{1} + {By}_{1} + {Cz}_{1} + D \vert}{\sqrt{{A}^{2} + {B}^{2} + {C}^{2}}} .$$

The sum

$${\sum }_{i = 1}^{n} {d}_{i}^{2}$$

represented by F(A,B,C,D) is given by:

$$F ( A , B , C , D ) = {\sum }_{i = 1}^{n} {d}_{i}^{2} = \frac{\begin{matrix}{( {Ax}_{1} + {By}_{1} + {Cz}_{1} + D )}^{2} + \\ {( {Ax}_{2} + {By}_{2} + {Cz}_{2} + D )}^{2} + … + {( {Ax}_{n} + {By}_{n} + {Cz}_{n} + D )}^{2}\end{matrix}}{{A}^{2} + {B}^{2} + {C}^{2}}$$

The value of A, B, C, D can be gotten by the following LaGrange multiplication method. Under the restriction A²+B²+C²=1:
F(A,B,C,D)=F(A,B,C,D)=(Ax₁+By₁+Cz₁+D)²+(Ax₂+By₂+Cz₂+D)²+ . . . +(Axₙ+Byₙ+Czₙ+D)².

According to LaGrange multiplication, we can construct the following equation:
G(A,B,C,D)=F′(A,B,C,D)+λ(A²+B²+C²−1)

Among it, λ is the LaGrange factor, which is a constant. The partial differential equations of G(A,B,C,D) about A, B, C, D are:

$$\frac{\partial G ( A , B , C , D )}{\partial A} = 0$$

$$\frac{\partial G ( A , B , C , D )}{\partial B} = 0$$

$$\frac{\partial G ( A , B , C , D )}{\partial C} = 0$$

$$\frac{\partial G ( A , B , C , D )}{\partial D} = 0$$

According to the above 4 equations, following equations can be derived:

$$\begin{matrix}A ( {\sum }_{i = 1}^{n} ( {x}_{i} * {x}_{i} ) + λ ) + B {\sum }_{i = 1}^{n} ( {x}_{i} * {y}_{i} ) + C {\sum }_{i = 1}^{n} ( {x}_{i} * {z}_{i} ) + D {\sum }_{i = 1}^{n} {x}_{i} = 0 & ( 1 ) \\ A {\sum }_{i = 1}^{n} ( {x}_{i} * {y}_{i} ) + B ( {\sum }_{i = 1}^{n} ( {y}_{i} * {y}_{i} ) + λ ) + C {\sum }_{i = 1}^{n} ( {y}_{i} * {z}_{i} ) + D {\sum }_{i = 1}^{n} {y}_{i} = 0 & ( 2 ) \\ A {\sum }_{i = 1}^{n} ( {x}_{i} * {z}_{i} ) + B {\sum }_{i = 1}^{n} ( {z}_{i} * {y}_{i} ) + C ( {\sum }_{i = 1}^{n} ( {z}_{i} * {z}_{i} ) + λ ) + D {\sum }_{i = 1}^{n} {z}_{i} = 0 & ( 3 ) \\ A {\sum }_{i = 1}^{n} {x}_{i} + B {\sum }_{i = 1}^{n} {y}_{i} + C {\sum }_{i = 1}^{n} {z}_{i} + nD = 0 & ( 4 ) \\ {A}^{2} + {B}^{2} + {C}^{2} = 1 & ( 5 )\end{matrix}$$

Among them, equation (4) can be rewritten as:

$$D = - \frac{1}{n} ( A {\sum }_{i = 1}^{n} {x}_{i} + B {\sum }_{i = 1}^{n} {y}_{i} + C {\sum }_{i = 1}^{n} {z}_{i} ) \qquad ( 6 )$$

Using equation (6), equations (1), (2), and (3) can be written as:

$$[ \begin{matrix}{\sum }_{i = 1}^{n} ( {x}_{i} * {x}_{i} ) - \frac{1}{n} {\sum }_{i = 1}^{n} ( {x}_{i} * {x}_{i} ) & {\sum }_{i = 1}^{n} ( {x}_{i} * {y}_{i} ) - \frac{1}{n} {\sum }_{i = 1}^{n} ( {x}_{i} * {y}_{i} ) & {\sum }_{i = 1}^{n} ( {x}_{i} * {z}_{i} ) - \frac{1}{n} {\sum }_{i = 1}^{n} ( {x}_{i} * {z}_{i} ) \\ {\sum }_{i = 1}^{n} ( {x}_{i} * {y}_{i} ) - \frac{1}{n} {\sum }_{i = 1}^{n} ( {x}_{i} * {y}_{i} ) & {\sum }_{i = 1}^{n} ( {y}_{i} * {y}_{i} ) - \frac{1}{n} {\sum }_{i = 1}^{n} ( {y}_{i} * {y}_{i} ) & {\sum }_{i = 1}^{n} ( {z}_{i} * {y}_{i} ) - \frac{1}{n} {\sum }_{i = 1}^{n} ( {z}_{i} * {y}_{i} ) \\ {\sum }_{i = 1}^{n} ( {x}_{i} * {z}_{i} ) - \frac{1}{n} {\sum }_{i = 1}^{n} ( {x}_{i} * {z}_{i} ) & {\sum }_{i = 1}^{n} ( {z}_{i} * {y}_{i} ) - \frac{1}{n} {\sum }_{i = 1}^{n} ( {z}_{i} * {y}_{i} ) & {\sum }_{i = 1}^{n} ( {z}_{i} * {z}_{i} ) - \frac{1}{n} {\sum }_{i = 1}^{n} ( {z}_{i} * {z}_{i} )\end{matrix} ] * [ \begin{matrix}A \\ B \\ C\end{matrix} ] = - λ [ \begin{matrix}A \\ B \\ C\end{matrix} ] \qquad ( 7 )$$

The value of A, B, C, D can be gotten by the above equations.

Except getting the values of A, B, C, D by said LaGrange multiplication method, the values can also be gotten with other methods such as linear recursion method.

After the values of A, B, C, D are gotten, the projection plane equation Ax+By+Cz+D=0 can be confirmed (step 121), by adding the equation of the vertical line of the projection plane

$$\frac{x - {x}_{i}}{A} = \frac{y - {y}_{i}}{B} = \frac{z - {z}_{i}}{C} ,$$

the following equations is derived:

$${x}^{′} = \frac{( {B}^{2} + {C}^{2} ) {x}_{i} - A ( {By}_{i} + {Cz}_{i} + D )}{{A}^{2} + {B}^{2} + {C}^{2}}$$

$$y = \frac{( {A}^{2} + {C}^{2} ) {y}_{i} - B ( {Ax}_{i} + {Cz}_{i} + D )}{{A}^{2} + {B}^{2} + {C}^{2}}$$

The corresponding 2D coordinates of every 3D sample point can be gotten by the said equations (step 122), no matter it belongs to the 3D track data that has been inputted or it belongs to the remained parts of the character inputted by users following.

Because most characters in English and Chinese contain more than two differentiable strokes, the 2D projection plane can be found (step 121) just by finding the first two differentiable strokes (step 119). Then, system can work out the 2D image of all 3D tracks of the character that the user inputs in 3D space.

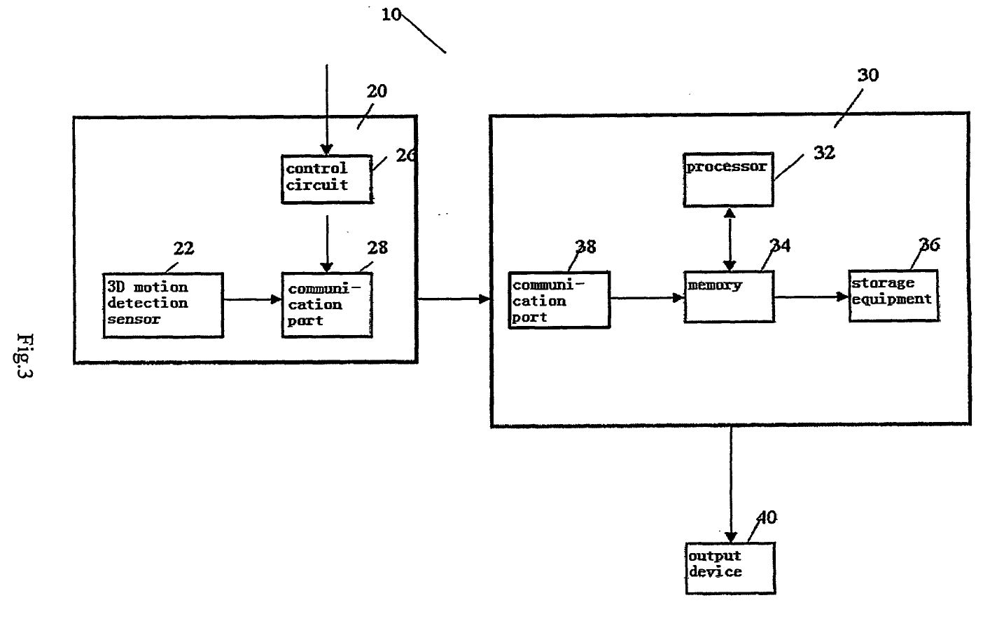

FIG. 3 shows an embodiment of 3D handwriting recognition system 10 according to the method introduced in the present invention. As the figure shown, system 10 contains the handwriting input equipment 20, the recognition equipment 30 and the output equipment 40. The input equipment 20 contains the 3D motion detection sensor 22, the control circuit 26 and the communication port 28. The recognition equipment 30 contains the processor 32, the memory 34, the storage equipment 36 and the communication port 38. For simplifying the system shown in the figure, other general components are not shown in FIG. 3. In other examples, the memory 34 can be independent from the recognition equipment 30, and connect to the recognition equipment 30 operationally.

During the operating process, the user moves the input equipment 20 in the 3D space to write character and/or symbol freely. The 3D motion detection sensor 22 detects the 3D motion and transmits the 3D movement data and the sampling rate to the recognition equipment 30 for handwriting recognition (step 102) by the communication port 28 (such as Bluetooth, Zigbee, IEEE802.11, Infrared ray or USB port) and the corresponding port 38. The sampling rate can be preset by the finial user or manufacture based on all kinds of factor (for example the processing ability of the system). Or, the sampling rate can be set and adjusted dynamically based on the moving speed. In the best example of the present invention, the sampling rate is adjusted dynamically based on the moving speed. First, make sure the initial moving speed related to handwriting input, then, the recognition equipment adjusts the sampling rate dynamically based on the speed of the last sample point. The speed higher, the sampling rate higher, and vice versa. By adjusting the sampling rate dynamically, the recognition precision can be increased, because only the points with the number neither too many nor too few can be used to construct character or symbol.

Based on the received movement data and sampling rate coming from the input equipment 20, the processor 32 occupies the memory 34, calculates the corresponding 3D coordinates on X, Y, and Z axes (step 106), and saves these coordinates to the storage equipment 36. Then, the processor 32 occupies the memory 34 to construct the corresponding 3D tracks by the calculated coordinates (step 116), and calculate the needed 2D projection plane (step 118). Then, maps those 3D tracks onto the 2D projection plane (step 122), so as to generate the 2D image that can be used in traditional handwriting recognition. The final result is shown on the output equipment 40.

Because the process of 3D writing is consecutive, the control circuit 26 in the input equipment 20 should provide a control signal by the port 28 in the input equipment and the port 38 in the recognition equipment (step 124), so as to separate different characters and symbols while receiving the input data. For example, after finish inputting a character or symbol, the user can push a control button so that the control circuit 26 generates a control signal.

The said system is an embodiment of the 3D handwriting recognition system applying the method of the present invention.

The processing time can be well decreased by the method provided in the present invention, which includes the course of deriving a 2D projection plane based on the 3D track data of some strokes of a character, mapping all tracks' data of the character onto the 2D projection plane to generate the corresponding 2D image for handwriting recognition. So, comparing with the original method, the user can get the finial result in much shorter time after completing character input. Thereby, the user does not need to wait a long time between writing two characters, which can provide pleased and natural input experience to him. Furthermore, the processing ability of the system is well improved.

Though the present invention is described referenced to the example, the example is just one embodiment of the invention, which does not restrict the content and application range of the present invention. The obviously replacing projects, modifications, and transfigurations, which can be gained easily according to the attached drawings and detailed description by the technicians being familiar with this field are also including in the spirit and range of the claims.

What is claimed is:

1. A handwriting recognition method, comprising the steps of:
1) calculating corresponding 3D coordinates based on 3D motion data:
2) constructing corresponding 3D tracks based on 3D coordinates;
3) deriving 2D projection plane based on the 3D tracks which have been inputted; and
4) generating 2D image for handwriting recognition by mapping the 3D tracks onto the 2D projection plane when the user inputs the rest of 3D motion data.

2. The method of claim 1, further comprising a step of generating 3D motion data by tracking corresponding 3D motion before step 1).

3. The method of claim 2, further comprising a step of adjusting the sampling rate dynamically based on the motion speed between the step of generating 3D motion data by tracking corresponding 3D motion and the step of calculating corresponding 3D coordinates based on 3D motion data.

4. The method of claim 1, further comprising a step of performing 2D handwriting recognition based on the 2D image after step 4).

5. The method of claim 1, wherein step 4) further comprising the steps of:
A) finding out the distinguishable strokes based on the 3D tracks which have been inputted; and
B) deriving 2D projection plane based on the said distinguishable strokes or part of them.

6. The method of claim 5, wherein step A) comprising the steps of:
a) finding out two different strokes; and
b) determining whether the average distance of the said two strokes is distinguishably qualified.

7. The method of claim 5, wherein step B) of deriving further comprising a step of deriving 2D projection plane as a plane to which the sum of the distance square of every sampling points is minimal.

8. The method of claim 5, wherein said distinguishable strokes in step B) is the first two distinguishable strokes.

9. The method of claim 6, wherein finding out two strokes in step a) is based on determining whether the motion direction of 3D tracks is changed.

10. The method of claim 6, wherein the average distance of said two distinguishable strokes in step b) is greater than a predetermined positive value.

11. The method of claim 7, wherein the step of deriving 2D projection plane as a plane to which the sum of the distance square of every sampling points is minimal can employ the LaGrange multiplication method.

12. The method of claim 9, wherein determining whether the motion direction is changed allows less than Nₘᵢₙ consecutive points move in different direction from prior points, Nₘᵢₙ is a predetermined natural number.

13. A handwriting recognition system, comprising:
an input device, including a 3D motion detection sensor to generate 3D motion data in response to 3D motion; and
a recognition device, in communication with the input device, to receive the 3D motion data, and derive the 2D images for handwriting recognition based on 3D motion data.

14. The system of claim 13, wherein the recognition device includes means for performing 2D handwriting recognition based on the 2D images.

15. The system of claim 13, wherein the recognition device includes:
means for calculating corresponding 3D coordinates based on the 3D motion data;
means for constructing corresponding 3D tracks based on the 3D coordinates; and
means for deriving the corresponding 2D images from the 3D tracks.

16. The system of claim 15, wherein the recognition device further includes means for adjusting the sampling rate dynamically based on the motion speed.

17. The system of claim 15, wherein the means for deriving the corresponding 2D images from the 3D tracks further includes means for mapping the 3D tracks onto a 2D plane to derive the 2D images for handwriting recognition.

18. The system of claim 17, wherein the deriving means further includes means for deriving 2D projection plane as a plane to which the sum of the distance square of every sampling points is minimal.

19. The system of claim 13, wherein the input device further includes a control circuit, responsive to a user's command, to generate a control signal transmitted to the recognition device indicating the completion of writing a word or character.

20. The system of claim 14, further comprising an output device for displaying the final result of handwriting recognition.

21. A processing system, comprising:
a memory;
an input device, including a 3D motion detection sensor, to generate 3D motion data in response to a 3D motion; and
a recognition device, operable coupled to the memory and in communication with the input device, which is configured to receive the 3D motion data and derive corresponding 2D images for handwriting recognition based on the 3D motion data.

22. The system of claim 21, wherein the recognition device includes means for performing 2D handwriting recognition based on the 2D images.

23. The system of claim 21, wherein the recognition device includes:
means for calculating corresponding 3D coordinates based on the 3D motion data;
means for constructing corresponding 3D tracks based on the 3D coordinates; and
means for deriving the corresponding 2D images from the 3D tracks.

24. The system of claim 23, wherein the deriving means includes means for mapping the 3D tracks onto a 2D plane to derive the 2D images for handwriting recognition.
